(19) United States
(12) Patent Application Publication
(10) Pub. No.: US 2024/0235769 A9
(43) Pub. Date: Jul. 11, 2024

(54) REFERENCE SIGNAL ALLOCATION CONTROL DEVICE AND OPERATION METHOD OF REFERENCE SIGNAL ALLOCATION CONTROL DEVICE

(71) Applicant: SK TELECOM CO., LTD., Seoul (KR)

(72) Inventors: Sung Hyun IEM, Seoul (KR); Kang Ho KIM, Seoul (KR)

(21) Appl. No.: 18/236,283

(22) Filed: Aug. 21, 2023

(30) Foreign Application Priority Data
Oct. 19, 2022 (KR) 10-2022-0135109

(51) Int. Cl. H04L 5/00

(52) U.S. Cl. CPC H04L 5/0051; H04L 5/0062

(57) ABSTRACT

The disclosure implements a dynamic CSI-RS allocation technique that minimizes a decrease in resources usable for data transmission due to overuse of LP-CSI-RS allocation, and also minimizes interference between an RS and a PDSCH, in consideration of a radio environment that dynamically varies.

### CROSS-REFERENCE TO RELATED APPLICATION(S)

This application is based on and claims priority under 35 U.S.C. 119 to Korean Patent Application No. 10-2022-0135109, filed on Oct. 19, 2022, in the Korean Intellectual Property Office, the disclosure of which is herein incorporated by reference in its entirety.

### BACKGROUND OF THE INVENTION

### 1. Field of the Invention

The disclosure relates to a technique that allocates an interference avoidance reference signal (e.g., an ZP-CSI-RS) for avoiding interference that affects data transmission.

### 2. Description of the Prior Art

In an LIE system, a cell-specific RS (CRS) allocated to the whole cell is used as a reference signal (RS) used for identifying a channel state between a base station and a user equipment (UE).

However, the use of such the CRS may restrict flexibility of the configuration of a network, and may be inefficient from the perspective of use of energy. In addition, it is difficult to apply the use of a CRS to a high-frequency band greater than or equal to 6 GHz, and the use of a CRS may be inappropriate for a multi-input multi-output (MIMO) system that uses multiple antennas.

Accordingly, instead of using a CRS that has been used in LIB, an NR (5G) that uses a high-frequency band and a MIMO system defines various types of RSs appropriate for various situations of the UE and exchanges an RS suitable for each beam of MIMO and thus the NR may be evolved to deal with different frequency bands and various scenarios.

A channel state information (CSI)-RS among RSs defined in the 5G may be an RS defined for estimating the state of a downlink channel that a base station (gNB) transmits to a UE.

In a process of estimating a downlink channel by using a CSI-RS, a base station (gNB) transmits a CSI-RS, a UE identifies/recognizes the state (situation) of a downlink channel based on the received CSI-RS and performs reporting of a result (CSI) to the base station (gNB). The base station (gNB) estimates, based on the received CSI report, the state (situation) of a downlink channel with the UE.

Accordingly, the base station (gNB) may perform, with respect to the UE, downlink scheduling (e.g., a modulation scheme, a code speed, the number of transmission layers, a MIMO precoding, and the like) based on channel estimation via a CSI report.

In a radio environment, in case that an RS and data (e.g., a PDSCH) are transmitted simultaneously (in the same resource location), interference between the RS and the PDSCH may occur. A success rate of reception of a PDSCH may be decreased due to interference, which is a drawback.

Accordingly, a technique that allocates a ZP-CSI-RS for preventing the occurrence of interference between the RS and the PDSCH has been introduced. By allocating the ZP-CSI-RS, interference affecting data transmission may be avoided.

In case that the ZP-CSI-RS is allocated, interference between the RS and the PDSCH in the corresponding resource location may be avoided. However, data corresponding to the resource location may not be transmitted and overhead may be increased, which is a drawback.

Accordingly, there is a desire for a GP-CSI-RS allocation scheme that minimizes a decrease in resources usable for data transmission due to overuse of LP-CSI-RS allocation, and also minimizes interference between the RS and the PDSCH.

In consideration of a radio environment that dynamically varies, the disclosure provides a dynamic CSI-RS allocation technique that minimizes a decrease in resources usable for data transmission due to overuse of LP-CSI-RS allocation, and also minimizes interference between an RS and a PDSCH.

### SUMMARY OF THE INVENTION

The disclosure is to provide a dynamic CSI-RS allocation technique that minimizes a decrease in resources usable for data transmission due to overuse of LP-CSI-RS allocation, and also minimizes interference between an RS and a PDSCH, in consideration of a radio environment that dynamically varies.

A reference signal allocation control device according to an embodiment of the disclosure may include an interference report receiver configured to receive an interference report associated with interference to a cell by another cell that does not interoperate with a distributed unit (DU) of the cell, and a controller configured to transfer reference signal information related to the interference report to the DU of the cell so that the DU allocates, based on the transferral information, a reference signal for avoiding interference to the cell.

Specifically, the device may further include an information management unit configured to periodically collect, from a plurality of DUs, reference signal information of each cell that includes a reference signal transmission location of cell controlled by each DU of the plurality of DUs, and the controller may be configured to transmit, to the DU of the cell, reference signal information of a specific cell specified by the interference report among the reference signal information of each cell collected for each of the plurality of DUs.

Specifically, the interference report is received from the DU of the cell, and may include an interference slot and an interference cycle based on a result obtained by identifying whether transmission data interference occurs in each slot for each cell controlled by the DU.

Specifically, the controller may transfer, to the DU of the cell, reference signal information of a predetermined cell that is controlled by another DU, instead of the DU of the cell, and that matches the interference slot and the interference cycle based on the interference report, from among the reference signal information of each cell managed for each of a plurality of DUs.

Specifically, when a deleted cell is identified based on information collection by the information management unit, the controller may transmit information indicating cancellation of use of reference signal information of the deleted cell to a DU that uses, for allocating an interference avoidance reference signal, the reference signal information of the deleted cell.

A distributed unit (DU) according to an embodiment of the disclosure may include an information securing unit configured to secure CSI-RS information associated with a cell of another DU that causes interference to a cell of the DU due to a CSI-RS, and an allocator configured to allocate, based on the secured information, a reference signal for avoiding interference to the cell of the DU.

Specifically, the information securing unit may secure the CSI-RS information associated with the cell of the other DU in a manner of transferring an interference report associated with the cell to a higher layer of the DU and receiving a response.

Specifically, the interference report may include an interference slot and an interference cycle based on a result obtained by identifying, for each cell controlled by the DU, whether transmission data interference occurs in each slot.

A radio unit (RU) interoperating with a distributed unit (DU) according to an embodiment of the disclosure may include a reference signal transmitter configured to transmit an interference avoidance reference signal in a resource location where a CSI-RS of another cell that does not interoperate with the DU is transmitted so that interference between transmission data and the CSI-RS of the other cell, which occurs in the resource location, is avoided.

Specifically, when the other cell is deleted, the reference signal transmitter may cancel transmission of the interference avoidance reference signal in the resource location so that the resource location is used for data transmission.

Specifically, the interference avoidance reference signal may be a zero power-channel state information-reference signal (ZP-CSI-RS).

An operation method of a reference signal allocation control device according to an embodiment of the disclosure may include an interference report reception operation for receiving an interference report associated with interference to a cell by another cell that does not interoperate with a distributed unit (DU) of the cell, and a control operation for transferring, to the DU of the cell, reference signal information related to the interference report so that the DU allocates, based on the transferral information, a reference signal for avoiding interference to the cell.

Specifically, the method may further include an information collection operation for periodically collecting, from a plurality of DUs, reference signal information of each cell that includes a reference signal transmission location of cell controlled by each DU of the plurality of DUs, and the control operation may transfer reference signal information of a specific cell specified by the interference report to the DU of the cell among the reference signal information of each cell collected for each of the plurality of DUs.

Specifically, the interference report is received from the DU of the cell, and may include an interference slot and an interference cycle based on a result obtained by identifying whether transmission data interference occurs in each slot for each cell controlled by the DU.

Specifically, the control operation may transfer, to the DU of the cell, reference signal information of a predetermined cell that is controlled by another DU, instead of the DU of the cell, and that matches the interference slot and the interference cycle based on the interference report, from among the reference signal information of each cell managed for each of a plurality of DUs.

Specifically, when a deleted cell is identified based on information collection in the information collection operation, the method may further include an operation of transferring information indicating cancellation of use of reference signal information of the deleted cell to a DU that uses, for allocating an interference avoidance reference signal, the reference signal information of the deleted cell.

An operation method of a distributed unit (DU) according to an embodiment of the disclosure may include an information securing operation for securing CSI-RS information associated with a cell of another DU that causes interference to a cell of the DU due to a CSI-RS, and an allocation operation for allocating, based on the secured information, a reference signal for avoiding interference to the cell of the DU.

An operation method of a radio unit (RU) that interoperates with a distributed unit (DU) according to an embodiment of the disclosure may include a reference signal transmission operation for transmitting an interference avoidance reference signal in a resource location where a CSI-RS of another cell that does not interoperate with the DU is transmitted so that interference between transmission data and the CSI-RS of the other cell, which occurs in the resource location, is avoided.

According to an embodiment of the disclosure, in consideration of a radio environment that dynamically varies, there may be provided an effect that minimizes a decrease in resources usable for data transmission due to overuse of LP-CSI-RS allocation, and that also minimizes interference between the RS and the PDSCH. Accordingly, the performance of transmission may be improved.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating an O-RAN system structure to which the disclosure is applicable.

FIG. 2 is a diagram illustrating the configuration of a reference signal allocation control device, a distributed unit (DU), and a radio unit (RU) according to an embodiment of the disclosure.

FIG. 3A is a diagram illustrating a situation in which an RS (e.g., an NLP-CSI-RS) of adjacent another cell causes interference to data transmission, and an example of identifying the same, and FIG. 3B is a diagram illustrating a situation in which an RS (e.g., an NZP-CSI-RS) of adjacent another cell causes interference to data transmission, and an example of identifying the same.

FIG. 4A is a diagram illustrating allocation of an interference avoidance reference signal (e.g., a ZP-CSI-RS) and an example of removing interference according to disclosure, and FIG. 4B is a diagram illustrating allocation of an interference avoidance reference signal (e.g., a ZP-CSI-RS) and an example of removing interference according to disclosure.

FIG. 5 is a flowchart illustrating an operation method of a reference signal allocation control device according to an embodiment of the disclosure.

FIG. 6 is a flowchart illustrating operation performed in a distributed unit (DU) according to an embodiment of the disclosure.

### DETAILED DESCRIPTION OF THE EXEMPLARY EMBODIMENTS

Hereinafter, embodiments of the disclosure are described with reference to the accompanying drawings.

The disclosure relates to a technique that allocates an interference avoidance reference signal (e.g., a ZP-CSI-RS).

In an LTE system, a cell-specific RS (CRS) allocated to the whole cell is used as a reference signal (RS) for identifying a channel state between a base station and a user equipment (UE).

However, the use of such the CRS may restrict flexibility of the configuration of a network, and may be inefficient from the perspective of use of energy. In addition, it is difficult to apply use of a CRS to a high-frequency region greater than or equal to 6 GHz, and the use of a CRS may be inappropriate for a multi-input multi-output (MIMO) system that uses multiple antennas.

Accordingly, instead of using a CRS that has been used in LTE, a user equipment (UE) defines various types of RSs appropriate for various situations of the UE and exchanges an RS suitable for each beam of MIMO in an NR (5G) that uses a high-frequency region and a MIMO system, and thus the NR may be evolved to deal with different frequency bands and various scenarios.

A channel state information (CSI)-RS among RSs defined in 5G may be an RS defined for estimating the state of a downlink channel that a base station (gNB) transmits to a UE.

In a process of estimating a downlink channel by using a CSI-RS, in case that a base station (gNB) transmits a CSI-RS, a UE identifies/recognizes the state (situation) of a downlink channel based on the received CSI-RS, and performs reporting of a result (CSI) to the base station (gNB). The base station (gNB) estimates, based on the received CSI report, the state (situation) of a downlink channel with the UE.

Accordingly, the base station (gNB) may perform, with respect to the UE, downlink scheduling (e.g., a modulation scheme, a code speed, the number of transmission layers, a MIMO precoding, and the like) based on channel estimation via a CSI report.

In a radio environment, in case that an RS and data (e.g., a PDSCH) are transmitted simultaneously (in the same resource location), interference between the RS and the PDSCH may occur. A success rate of reception of a PDSCH may be decreased (an increase in BLERs) due to interference, which is a drawback.

Accordingly, a technique that allocates a GP-CSI-RS for preventing the occurrence of interference between an RS and a PDSCH has been introduced. Via such the LP-CSI-RS allocation, interference between an RS and a PDSCH, which affects data transmission, may be avoided.

A ZP-CSI-RS is classified as a ZP-CSI-RS that transmits an empty CSI-RS, that is, a CSI-RS that does not transmit energy in an allocated resource location, and an NZP-CSI-RS that transmits a CSI-RS by transmitting energy in an allocated resource location. The allocation and management of such a CSI-RS may be controlled by a distributed unit (e.g., DU) of a corresponding cell.

In case that an ZP-CSI-RS is allocated, interference between an RS and a PDSCH in the corresponding resource location may be avoided. However, data corresponding to the resource location may not be transmitted and overhead may be increased, which is a drawback.

Given that a change in an environment irregularly occurs in a radio environment such as addition or deletion of an adjacent cell, in case that ZP-CSI-RS allocation is unnecessarily overused, the amount of resource usable for data transmission may be decreased, which is a drawback.

When a DU needs to allocate a ZP-CSI-RS in a cell (hereinafter, a serving cell), information associated with a CSI-RS of an adjacent another cell that is in an interference relationship with the serving cell may be needed.

However, in case that the adjacent other cell interoperates with a DU different from that of the serving cell, the DU of the serving cell may be incapable of identifying information associated with the CSI-RS of the adjacent other cell. Accordingly, it is difficult to appropriately allocate a ZP-CSI-RS to minimize interference.

To overcome such the drawback and problem, in consideration of a radio environment that dynamically varies, the disclosure provides a dynamic CSI-RS allocation technique that minimizes a decrease in resources usable for data transmission due to overuse of LP-CSI-RS allocation, and also minimizes interference between an RS and a PDSCH.

The disclosure is not limited to the 5G (NR), and may be broadly applicable to a general radio mobile communication system including the 4G (LTE) and 6G in the future.

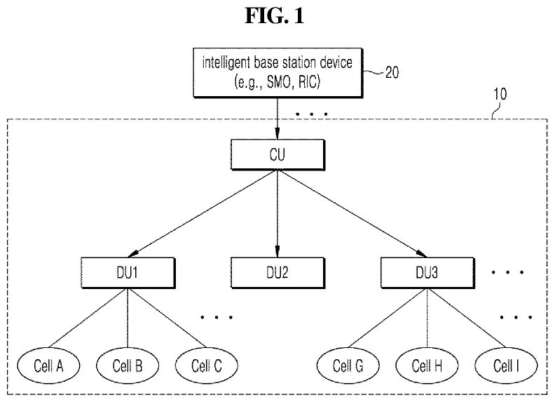

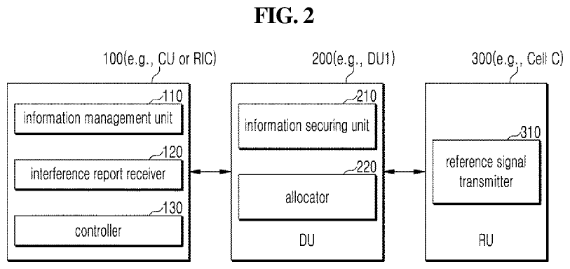

For example, the disclosure is applicable to an O-RAN system that is based on open radio access network (O-RAN) technology as illustrated in FIG. 1.

Briefly describing, an O-RAN is technology for standardizing an interface that connects devices needed for implementation of a base station device 10 so that the devices interoperate. Based on the O-RAN, a radio unit (O-RU) and a base station (centralized unit (O-CU)/distributed unit (O-DU)) of different manufacturers/vendors may interoperate and may perform operation.

The O-RAN system based on such the O-RAN has an architecture in which devices developed by different manufacturers/vendors, that is, an O-CU, an O-DU, and an O-RU, operate by interoperating with devices of an intelligent base station control device 20 for controlling the base station devices 10 (O-CU/O-DU/O-RU) including the devices.

That is, as shown in FIG. 1, the O-RAN system is designed to have a structure for implementing an open and intelligent radio access network.

The O-RAN system may be briefly divided into the base station device 10 embodied separately as an O-CU, an O-DU, and an O-RU, and the intelligent base station control device 20 (e.g., an SMO, RIC, or the like) to control the base station devices.

In the intelligent base station control device 20, a service management and orchestration framework (SMO) and a RAN intelligent controller (RIC) may be defined.

An RU (or O-RU) performs radio signal processing, and is illustrated as each cell in FIG. 1.

A CU (or O-CU) is divided into a control plane (O-CU-CP) for transferring control information and a user plane (O-CU-UP) for transferring traffic, and may perform a control command received from the intelligent base station control device 20.

A DU (or O-DU) is in charge of baseband signal processing and a real time layer 2 (L2) function in a radio link control layer and a medium access control layer.

In addition, a plurality of cells (e.g., Cell A, B, C) may be connected to a single DU (e.g., DU 1), and the DU (e.g., DU 1) may manage configuration/scheduling or the like of each cell (e.g., Cell A, B, and C).

That is, the DU (e.g., DU 1) is in charge of allocating and managing a CSI-RS related resource location (time domain & frequency domain) for each cell (e.g., Cell A, B, C) that subordinately interoperates with the DU.

As described above, in an open RAN system that has an architecture in which devices (e.g., a CU, an RIC, an SMO, and the like) intemperate in a higher layer of a DU (or O-DU), a subordinate DU is controlled by utilizing a higher layer (e.g., a CU, an RIC, an SMO, and the like) of the DU (or O-DU). Accordingly, availability and efficiency may be high in case that the disclosure is applied.

The disclosure is not limited to application of the O-RAN system, and may be applicable to various types of radio mobile communication system environments.

Hereinafter, referring to FIG. 2, the configuration of the reference signal allocation control device 100 for implementing a dynamic CSI-RS allocation technique of the disclosure will be described in detail.

Before describing in detail, the disclosure may be applicable to the 4G (LTE), the 5G (NR), the 6G in the further, or the like.

In the descriptions hereinafter, for ease of description, the features and various embodiments of the disclosure will be described based on the 5G (NR) standard.

As illustrated in FIG. 2, a reference signal allocation control device 100 according to an embodiment of the disclosure may include an information management unit 110, an interference report receiver 120, and a controller 130.

The whole or at least a part of the configuration of the reference signal allocation control device 100 may be embodied in the form of a hardware module or a software module, or may be embodied in the form of a combination of a hardware module and a software module.

Here, the software module may be considered as, for example, an instruction executed by a processor that controls an operation in the reference signal allocation control device 100, and such an instruction may be in the form of being contained in memory in the reference signal allocation control device 100.

Therefore, the reference signal allocation control device 100 according to an embodiment of the disclosure may implement a dynamic CSI-RS allocation technique provided in the disclosure via the above-described configuration.

If it is assumed that the disclosure is applied to an O-RAN system, the reference signal allocation control device 100 of the disclosure may be implemented in a higher layer (e.g., a CU, an RIC, an SMO, or the like) of a DU (or an O-DU), and part of the configuration (functions) of the reference signal allocation control device 100 of the disclosure may be implemented distributively in a higher layer (e.g., a CU, an RIC, an SMO, or the like) of a DU (or an O-DU).

Hereinafter, for ease of description, description will be provided with reference to an embodiment in which the reference signal allocation control device 100 of the disclosure is implemented in the RIC 20.

Hereinafter, each configuration of the reference signal allocation control device 100 will be described in detail.

The information management unit 110 may be in charge of a function that periodically collects, from a plurality of DUs, reference signal information of each cell that includes a reference signal transmission location of the corresponding cell controlled by the corresponding DU.

For example, the information management unit 110 may periodically collect reference signal information of each cell from a plurality of DUs in a manner of periodically requesting, from the plurality of DUs (e.g., DU 1, 2, 3, . . . ), CSI-RS information for each cell, and receiving a response.

Accordingly, the information management unit 110 may periodically collect/store, in real time from the plurality of DUs (e.g., DU 1, 2, 3, . . . ), CSI-RS information of each cell that includes a CSI-RS transmission location (time domain & frequency domain) that the corresponding DU (e.g., DU 1) allocates and controls in the corresponding cell (e.g., cell A, B, C).

Accordingly, the information management unit 110 may store/update/manage CSI-RS information of each cell (e.g., cell A, B, C, H, I, . . . ) as the latest information, for each of the plurality of DUs (e.g., DU 1, 2, 3, . . . ).

In addition, based on the above-described periodic information collection, the information management unit 110 may identify whether a cell that is deleted is present.

For example, in case that there is a cell of which CSI-RS information is not received/collected although a cycle has come in the process in which the information management unit 110 collects CSI-RS information of each cell for each DU from the plurality of DUs (e.g., DU 1, 2, 3, . . . ) as described above, the information management unit 110 may identify that the corresponding cell as a deleted cell.

Alternatively, in case that there is a cell of which CSI-RS information is not received/collected at least a predetermined N times (e.g., 3 times) although a cycle has come in the process in which the information management unit 110 collects CSI-RS information of each cell for each corresponding DU from the plurality of DUs (e.g., DU 1, 2, 3, . . . ) as described above, the information management unit 110 may identify that the corresponding cell as a deleted cell.

In this instance, the information management unit 110 may delete the CSI-RS information of the cell of which deletion is identified from the CSI-RS information managed for each cell (e.g., cell A, B, C, H, I, . . . ), so as to update/manage, as the latest information, CSI-RS information of each cell (e.g., cell A, B, C, H, I, . . . ) for each subordinate DU (e.g., DU 1, 2, 3, . . . ).

An interference report receiver 120 may be in charge of a function of receiving an interference report associated with interference to a cell by another cell that does not interoperate with a DU of the cell.

In this instance, the interference report is received from the DU of the cell, and may be a report that is transferral by including an interference cycle and an interference slot based on a result obtained by identifying whether transmission data interference occurs in units of slots for each cell controlled by the DU.

Describing in detail with reference to DU 1 among a plurality of DUs (e.g., DU 1, 2, 3, . . . ), DU 1, as described above, may periodically transfer, to the reference signal allocation control device 100 (e.g., the RIC 20) of the disclosure, real-time CSI-RS information of each cell that includes a CSI-RS transmission location that corresponding cell (e.g., cell A, B, C) allocates and controls.

In the disclosure, DU 1 may estimate whether a CSI-RS causes interference to transmission data for each cell (e.g., cell A, B, C) of DU 1 (hereinafter, whether interference to transmission data is present), and may identify the same.

Describing in detail, DU 1 may estimate/identify, for each cell (e.g., cell A, B, C) of DU 1, whether transmission data interference occurs in units of slots, and during the estimation/identification process, a hybrid automatic repeat request (HARQ)-based block error rate (BLER) may be utilized.

Generally, a DU may have an ACK/NACK-based HARQ operation function for transmission data, and may calculate a BLER for each slot by utilizing the HARQ operation. Accordingly, in the disclosure, based on a BLER of each slot calculated for each cell (e.g., cell A, B, C) of DU 1, DU 1 may recognize whether a slot having a BLER greater than a target BLER is present, and may recognize a cycle by which such the interference (the occurrence of a BLER greater than the target BLER) occurs.

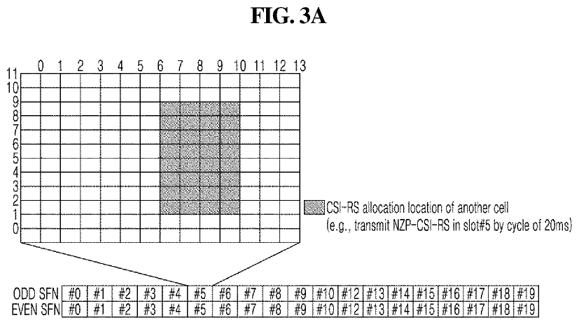

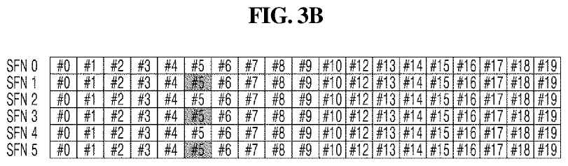

Describing in detail with reference to FIGS. 3A and 3B, as illustrated in FIG. 3A, it is assumed that another cell (e.g., cell G) that is adjacent to a cell of DU 1, is controlled by another DU (e.g., DU 3), and allocates a CSI-RS (e.g., an NZP-CSI-RS) in a location of slot #5 by a cycle of 20 ms, is present.

In this instance, as illustrated in FIG. 3B, in the cell (e.g., cell C) of DU 1, interference may occur in data that is transmitted in a resource location same as that of the CSI-RS (e.g., an NZP-CSI-RS) of the adjacent other cell (e.g., cell G), that is, the location of slot #5 by a cycle of 20 ms.

Accordingly, DU 1 may periodically recognize that a BLER greater than a target BLER occurs in the location of slot #5 by a cycle of 20 ms with respect to cell C of DU 1.

In this instance, DU 1 in the disclosure may estimate/identify that transmission data interference is present with respect to a serving cell (e.g., cell C) in which the transmission data interference is identified as occurring in the location of slot #5 by a cycle of 20 ms among its cells (e.g., cell A, B, C), and may produce an interference report related thereto and transmit the same to the reference signal allocation control device 100 (e.g., RIC 20).

As described above, the interference report transferred to the reference signal allocation control device 100 (e.g., the RIC 20) of the disclosure may be received from a DU (e.g., DU 1) of a cell that is identified as experiencing transmission data interference, and may include an interference slot and an interference cycle (e.g., slot #5 by a cycle of 20 ms) associated with the identified transmission data interference.

In the disclosure, in case that another cell that causes transmission data interference with respect to its serving cell (e.g., cell C) is a subordinate cell (e.g., cell B or C) of DU 1, DU 1 may be already aware of information associated with a CSI-RS of the corresponding cell (e.g., cell B or C), and thus DU 1 does not perform a subsequent operation according to the disclosure and may allocate a ZP-CSI-RS with respect to the serving cell (e.g., cell C) according to the conventional method.

Therefore, DU 1 in the disclosure, only in case that the other cell that causes transmission data interference with respect to its serving cell (e.g., cell C) is a cell that does not interoperate with DU 1, the DU1 may produce and transfer an interference report related thereto.

In the same manner as described above, in the disclosure, each of a plurality of DUs (e.g., DU 1, 2, 3, . . . ) including DU 1 may produce and transfer an interference report for a serving cell in which transmission data interference is identified.

Accordingly, the interference report receiver 120 may receive an interference report for the corresponding cell (e.g., cell C), particularly, an interference report associated with interference by another cell that does not interoperate with the predetermined DU (e.g., DU 1), from the DU (e.g., DU 1) of the cell (e.g., cell C) in which transmission data interference is identified (e.g., cell C) among the plurality of DUs (e.g., DU 1, 2, 3, . . . ).

The controller 130 may be in charge of a function that transfers, to the DU of the cell, reference signal information related to the interference report received via the interference report receiver 120 so that the DU is in charge of allocating, based on the transferred information, a reference signal for avoiding interference to the cell.

For ease of description, as shown in the above description of the embodiment provided with reference to FIGS. 3A and 3B, description will be continuously provided with reference to the situation in which transmission data interference periodically occurs due to a CSI-RS (e.g., an NZP-CSI-RS) of another cell (cell G) in a location of slot #5 by a cycle of ms in cell C, and DU 1 transfers an interference report related thereto (e.g., slot #5 by a cycle of 20 ms).

In case that an interference report (e.g., slot #5 by a cycle of 20 ms) is received from DU 1 via the interference report receiver 120, the controller 130 may transfer reference signal information related to the received interference report (e.g., slot #5 by a cycle of 20 ms) to DU 1.

The controller 130 may transfer, to DU 1, the reference signal information related to the received interference report (e.g., slot #5 by a cycle of 20 ms) to enable DU 1 to allocate, based on the transferral information, an interference avoidance reference signal for cell C.

In this instance, the interference avoidance reference signal may be a zero power-channel state information-reference signal (ZP-CSI-RS) or non-zero power (NZP)-CSI-RS.

According to an embodiment, the controller 130 may transfer, to DU1 of the cell C, reference signal information of a cell specified by the present interference report (e.g., slot #5 by a cycle of 20 ms) among the reference signal information of each cell (e.g., cell A, B, C, H, I, . . . ) collected for each of a plurality of DUs (e.g., DU 1, 2, 3, . . . ).

As described above, the information management unit 110 may update/manage, as the latest information, reference signal information, that is, CSI-RS information, of each cell (e.g., cell A, B, C, H, I, . . . ) for each of a plurality of DUs (e.g., DU 1, 2, 3, . . . ).

Accordingly, in case that an interference report (e.g., slot #5 of a cycle of 20 ms) is received from DU 1 via the interference report receiver 120, the controller 130 may extract CSI-RS information of a cell specified by the present interference report (e.g., slot #5 by a cycle of 20 ms) from among the CSI-RS information of each cell (e.g., cell A, B, C, H, managed for each DU (e.g., DU 1, 2, 3, . . . ), and may transfer the same to DU 1 of cell C.

More particularly, the controller 130 may extract CSI-RS information of a predetermined cell that is controlled by another DU (e.g., DU 2, 3 . . . ) instead of DU 1 and that matches an interference slot (e.g., slot #5) and an interference cycle (e.g., a cycle of ms) based on the present interference report (slot #5 by a cycle of 20 ms) from among the CSI-RS information of each cell (e.g., cell A, B, C, H, I . . . ) managed for each DU (e.g., DU 1, 2, 3, . . . ), and may transfer the same to DU 1 of cell C.

In case of the situation of the embodiment described with reference to FIGS. 3A and 3B, the controller 130 may extract CSI-RS information of cell Gas CSI-RS information of a predetermined cell that is controlled by another DU (e.g., DU 2, 3 . . . ) instead of DU 1 and that matches an interference slot (e.g., slot #5) and an interference cycle (e.g., a cycle of ms) based on the present interference report (slot #5 by a cycle of 20 ms) from among the CSI-RS information of each cell (e.g., cell A, B, C, H, I . . . ) managed for each DU (e.g., DU 1, 2, 3, . . . ), and may transfer the same to DU 1.

In addition, in case that an interference report includes a separate cell identifier capable of identifying a cell, the controller 130 may extract CSI-RS information of a predetermined cell based on a cell identifier of the present interference report (e.g., a cell identifier, slot #5 by a cycle of 20 ms) from among the CSI-RS information of each cell (e.g., cell A, B, C, . . . H, I, . . . ) managed for each DU (e.g., DU 1, 2, 3, . . . ), and may transfer the same to DU 1 of cell C.

Accordingly, in case that cell G allocates and uses an NZP-CSI-RS as a CSI-RS, CSI-RS information including an NZP-CSI-RS transmission location of cell G may be transferred/provided as a reply to DU 1 that transfers the inference report associated with its serving cell (cell C).

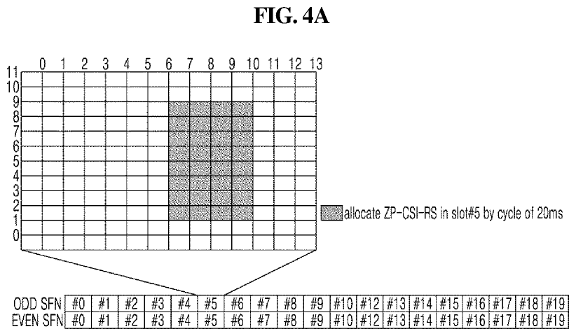

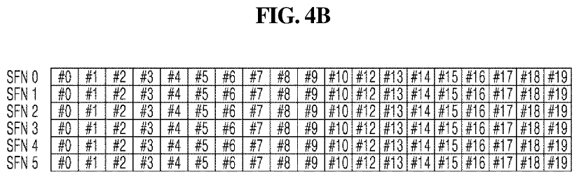

In this manner, DU 1 may secure CSI-RS information (including an NZP-CSI-RS transmission location) associated with cell G of DU 3 that does not interoperate with DU 1, and, by using the same, may allocate a ZP-CSI-RS for its serving cell, that is, the cell C, to the same transmission location (e.g., slot #5 by a cycle of 20 ms) as shown in FIG. 4A. Accordingly, as illustrated in FIG. 4B, cell C of DU 1 may allocate/use, for ZP-CSI-RS transmission, a location of slot #5 by a cycle of 20 ms, that is, a resource location same as that of an NZP-CSI-RS of cell G that is subordinate of DU3 that does not intemperate with DU 1, thereby removing/avoiding interference to transmission data that has occurred in the corresponding location.

In case that cell G allocates and uses a ZP-CSI-RS as a CSI-RS, DU 1 in the disclosure may secure CSI-RS information associated with cell G of DU 3 that does not interoperate with DU 1, and thus DU 1 may allocate an optimal CSI-RS and may avoid interference in a manner of allocating an NZP-CSI-RS for cell C, that is, its serving cell to the same transmission location by using the CSI-RS information (including ZP-CSI-RS transmission location) associated with the cell G.

As described above, according to the disclosure, by implementing detailed technology in a DU and a higher layer of the DU, even though cells do not intemperate with the same DU, the cells may recognize a CSI-RS transmission location in each cell in real time and may use the same for ZP-CSI-RS allocation.

In addition, in case that a cell that is deleted is identified based on information collection of the information management unit 110, the controller 130 may transfer information indicating cancellation of use of reference signal information of the cell of which deletion is identified to a DU that uses, for ZP-CSI-RS allocation, CSI-RS information of the cell of which deletion is identified.

As described above, the information management unit 110 may delete the CSI-RS information of the cell of which deletion is identified from the CSI-RS information managed for each cell (e.g., cell A, B, C, H, I, . . . ), so as to update/manage, as the latest information, CSI-RS information of each cell (e.g., cell A, B, C, . . . , H, I, . . . ) for each subordinate DU (e.g., DU 1, 2, 3, . . . ).

As described above, the controller 130 may identify a cell that is deleted from the above-described operation of deleting, by the information management unit 110, CSI-RS information of a cell of which deletion is identified.

Describing an embodiment in which a cell identified as being deleted is cell G, in case that the controller 130 identifies that cell G is a deleted cell, the controller 130 may transfer information indicating cancellation of use of CSI-RS information of the cell G of which deletion is identified to a DU, for example, the above-described DU 1, that uses, for ZP-CSI-RS allocation, the CSI-RS information of cell G of which deletion is identified.

For example, the controller 130 may cancel use of CSI-RS information of cell G in a manner of updating the CSI-RS information of cell G transferred in advance to DU 1 that uses, for ZP-CSI-RS allocation, the CSI-RS information of cell G of which deletion is identified.

Alternatively, the controller 130 may transfer control information for cancelling use of the CSI-RS information of cell G to DU 1 that uses, for ZP-CSI-RS allocation, CSI-RS information of cell G of which deletion is identified.

In this manner, DU 1 in the disclosure may cancel the use of CSI-RS information of cell G based on CSI-RS information update or control information transferring, and thus DU 1 may cancel ZP-CSI-RS allocation that is allocated in advance to its serving cell, that is cell C, by using CSI-RS information (including an NZP-CSI-RS transmission location) of cell G, and utilize corresponding resource for data transmission, and thus unnecessary ZP-CSI-RS allocation may be reduced.

In addition, as illustrated in FIG. 2, a distributed unit (DU) 200 according to an embodiment of the disclosure may include an information securing unit 210 and an allocator 220.

The information securing unit 210 may be in charge of a function that secures CSI-RS information for a cell of another DU that causes interference to a cell of the DU 200 due to a CSI-RS.

Specifically, the information securing unit 210 may secure CSI-RS information for the cell of the other DU in a manner of transferring an interference report for the cell to a higher layer of the DU 200 and receiving a replay.

In this instance, the transferral interference report may include an interference slot and an interference cycle associated with a result obtained by identifying whether transmission data interference occurs in units of slots for each cell controlled by the DU 200.

Describing a detailed embodiment on the assumption that that the DU 200 of the disclosure is the above-described DU 1, it may be assumed that another cell (e.g., cell G) that is adjacent to a cell (e.g., cell C) of the DU 200, is controlled by another DU (e.g., DU 3), and allocates a CSI-RS (e.g., an NZP-CSI-RS) to a location of slot #5 by a cycle of 20 ms, is present, as illustrated in FIG. 3A.

In this instance, in the cell (e.g., cell C) of DU 200, interference may occur in data that is transmitted in a resource location same as that of the CSI-RS (e.g., an NZP-CSI-RS) of the adjacent other cell (e.g., cell G), that is, the location of slot #5 by a cycle of 20 ms.

Accordingly, the DU 200 of the disclosure may estimate/identify that transmission data interference is present with respect to a serving cell (e.g., cell C) in which the transmission data interference is identified as occurring in a location of slot #5 by a cycle of ms among its cells (e.g., cell A, B, C), and may produce an interference report related thereto and transmit the same to a higher layer of the DU 200 (e.g., the reference signal allocation control device 100).

As described above, the interference report transferred by the DU 200 of the disclosure may include an interference slot and an interference cycle (e.g., slot #5 by a cycle of 20 ms) associated with a cell (e.g., cell C) identified as being affected by transmission data interference.

Accordingly, the information securing unit 210 may secure CSI-RS information (e.g., including an NZP-CSI-RS transmission location) associated with another cell (e.g., cell G) of another DU (e.g., DU 3) in a manner of receiving/obtaining as a reply, CSI-RS information associated with another cell (e.g., cell G) of another DU (e.g., DU 3) related to the present interference report from a higher layer (e.g., the reference signal allocation control device 100) of the DU 200 that receives an interference report.

Based on the information secured from the information securing unit 210, the allocator 220 may allocate an interference avoidance reference signal for avoiding interference to the cell, that is, may perform ZP-CSI-RS allocation.

Describing a detailed embodiment by assuming that the DU 200 of the disclosure is the above-described DU 1, the DU 200 of the disclosure may secure, from the information securing unit 210, CSI-RS information (including an NZP-CSI-RS transmission location) for cell G of DU 3 that does not intemperate with the DU 200 of the disclosure.

Accordingly, the allocator 220 may allocate a ZP-CSI-RS for its cell C to the same transmission location (e.g., slot #5 by a cycle of 20 ms) as illustrated in FIG. 4A, by using the secured CSI-RS information (including an NZP-CSI-RS transmission location) for cell G of DU 3.

In addition, as illustrated in FIG. 2, a radio unit (RU) 300 according to an embodiment of the disclosure may interoperate with the DU 200.

The RU 300 according to an embodiment of the disclosure may include a reference signal transmitter 310.

The reference signal transmitter 310 may be in charge of a function that transmits an interference avoidance reference signal in the resource location same as that of a CSI-RS of another cell that does not interoperate with the DU 200, and that avoids interference between the CSI-RS of the other cell and the transmission data, which has been occurred in the resource location.

Describing a detailed embodiment on the assumption that that the DU 200 is the above-described DU 1, as described above, and the RU 300 of the disclosure is cell C, it may be assumed that another cell (e.g., cell G) that is adjacent to the RU 300 (e.g., cell C), is controlled by another DU (e.g., DU 3), and allocates a CSI-RS (e.g., an NZP-CSI-RS) to a location of slot #5 by a cycle of 20 ms, is present, as illustrated in FIG. 3A.

In this instance, in the RU 300 (e.g., cell C), interference may occur in data that is transmitted in a resource location same as that of the CSI-RS (e.g., an NZP-CSI-RS) of the adjacent other cell (e.g., cell G), that is, the location of slot #5 by a cycle of 20 ms.

Accordingly, the RU 300 (cell C) of the disclosure, particularly, the reference signal transmitter 310, may transmit an interference avoidance reference signal (ZP-CSI-RS) in the resource location same as that of the CSI-RS of cell G which is another cell of DU 3 that does not intemperate with the DU 200, that is, in a location of slot #5 by a cycle of 20 ms, so that interference (interference between an RS and a PDSCH) between the CSI-RS of cell G and transmission data of cell C, which occurs in the corresponding resource location may be avoided.

In addition, in case that the other cell (e.g., cell G of DU 3) is deleted, the RU 300 (cell C) of the disclosure, particularly, the reference signal transmitter 310 may cancel transmission of a ZP-CSI-RS in the corresponding resource location (e.g., a location of slot #5 by a cycle of 20 ms), so that the corresponding resource location is used for data transmission.

As described above, according to the disclosure, by implementing detailed technology in a DU and a higher layer of the DU, even though cells do not intemperate with the same DU, the cells may recognize a CSI-RS transmission location in each cell in real time and may use the same for ZP-CSI-RS allocation.

Therefore, according to an embodiment of the disclosure, in consideration of a radio environment that dynamically varies, there may be provided an effect that minimizes a decrease in resources usable for data transmission due to overuse of ZP-CSI-RS allocation, and that also minimizes interference between an RS and a PDSCH. Accordingly, the performance of transmission may be improved.

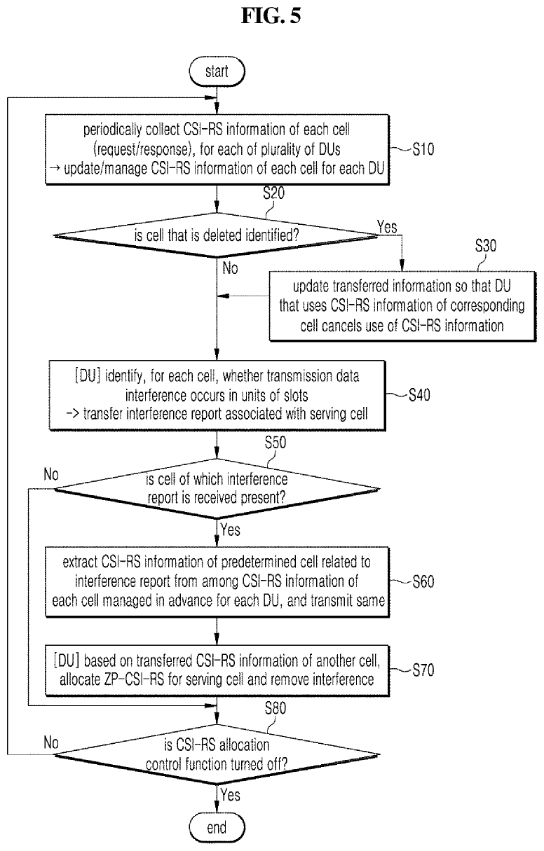

Hereinafter, referring to FIG. 5, an operation method of a reference signal allocation control device according to an embodiment of the disclosure will be described. For ease of description, description will be provided with reference to reference numeral 100 illustrated in FIG. 2.

In an operation method of a reference signal allocation control device according to an embodiment of the disclosure, the reference signal allocation control device 100 may periodically collect CSI-RS information of each cell controlled by corresponding DU for each of the plurality of DUs in operation S10.

For example, the reference signal allocation control device 100 may periodically collect reference signal information of each cell from a plurality of DUs in a manner of periodically requesting, from the plurality of DUs (e.g., DU 1, 2, 3, . . . ), CSI-RS information for each cell, and receiving a response.

In the operation method of a reference signal allocation control device according to an embodiment of the disclosure, the reference signal allocation control device 100 may periodically collect and store, for each of the plurality of DUs (e.g., DU 1, 2, 3, . . . ), real-time CSI-RS information of each cell that includes a CSI-RS transmission location (time domain & frequency domain) that corresponding DU (e.g., DU 1) allocates and controls in the corresponding cell (e.g., cell A, B, C), and may update/manage, as the latest information, the CSI-RS information of each cell (e.g., cell A, B, C, . . . , H, I, . . . ) for each subordinate DU (e.g., DU 1, 2, 3, . . . ) in operation S10.

In the operation method of the reference signal allocation control device according to an embodiment of the disclosure, in case that there is a cell of which CSI-RS information is not received/collected although a cycle has come in the process that the reference signal allocation control device 100 collects CSI-RS information of each cell for each corresponding DU from the plurality of DUs (e.g., DU 1, 2, 3, . . . ), the reference signal allocation control device 100 may identify that the corresponding cell as a deleted cell (Yes in operation S20).

In the operation method of the reference signal allocation control device according to an embodiment of the disclosure, in case that a deleted cell (e.g., cell G) is identified (Yes in operation S20), the reference signal allocation control device 100 may transfer information indicating cancellation of use of CSI-RS information of cell G of which deletion is identified to a DU that uses, for ZP-CSI-RS allocation, CSI-RS information of cell G of which deletion is identified in operation S30.

Describing an embodiment in which the cell of which deletion is identified is cell G, the reference signal allocation control device 100 may update the CSI-RS information of cell G transferral in advance to DU 1 that uses, for ZP-CSI-RS allocation, CSI-RS information of cell G of which deletion is identified, so as to cancel the use of CSI-RS information of cell G, or may transfer control information indicating cancellation of use of the CSI-RS information of cell G in operation S30.

In this manner, DU 1 in the disclosure may cancel the use of CSI-RS information of cell G based on CSI-RS information update or control information transferring, and thus DU 1 may cancel ZP-CSI-RS allocation that is allocated in advance to its serving cell, that is cell C, by using CSI-RS information (including an NZP-CSI-RS transmission location) of cell G, and may utilize corresponding resource for data transmission, and thus unnecessary ZP-CSI-RS allocation may be reduced.

Continuously describing again, in the operation method of the reference signal allocation control device according to an embodiment of the disclosure, the reference signal allocation control device 100 may identify whether there is a cell of which an interference report is received in operation S50.

Describing in detail with reference to DU 1 among a plurality of DUs (e.g., DU 1, 2, 3, . . . ), DU 1 in the disclosure may estimate/identify whether interference to transmission data caused by a CSI-RS is present (hereinafter, whether transmission data interference is present) for each cell (e.g., cell A, B, C) in operation S40.

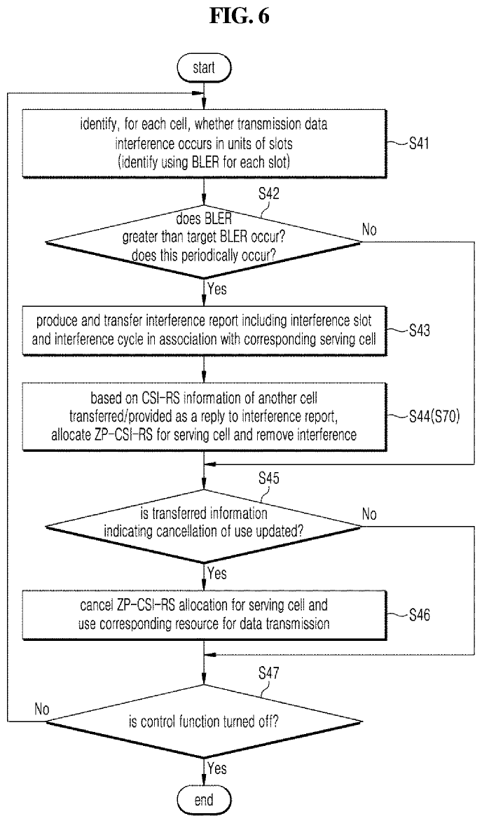

Operation S40 will be described in detail in the descriptions (S41 to S43) with reference to FIG. 6.

In the disclosure, in case that a cell (e.g., cell C) that is estimated/identified as being affected by transmission data interference is present among its cell (e.g., cell A, B, C), DU 1 may produce an interference report including an interference slot and an interference cycle (e.g., slot #5 by a cycle of 20 ms) associated with the transmission data interference identified for the corresponding serving cell (e.g., cell C), and may transfer the same to the reference signal allocation control device 100 (e.g., the RIC 20) of the disclosure in operation S40. Accordingly, in the operation method of the reference signal allocation control device according to an embodiment of the disclosure, in case that the reference signal allocation control device 100 identifies that a cell of which an interference report is received, for example, cell C is present (Yes in operation S50), the reference signal allocation control device 100 may extract CSI-RS information of a cell specified by the present interference report (e.g., slot #5 by a cycle of 20 ms) from CSI-RS information of each cell (e.g., cell A, B, C, H, I, . . . ) managed in advance for each DU (e.g., DU 1, 2, 3, . . . ), and may transfer the same to DU 1 of cell C in operation S60.

More particularly, the reference signal allocation control device 100 may transfer, to DU 1 of cell C, CSI-RS information of a predetermined cell that is controlled by another DU (e.g., DU 2, 3, . . . ) instead of DU 1 and that matches an interference slot (e.g., slot #5) and an interference cycle (e.g., a cycle of 20 ms) based on the present interference report (slot #5 by a cycle of 20 ms) from among the CSI-RS information of each cell (e.g., cell A, B, C, . . . , H, I, . . . ) managed in advance for each DU (e.g., DU 1, 2, 3, . . . ).

As described in the embodiment with reference to FIG. 3A and FIG. 3B, in case that transmission data interference periodically occurs in a location of slot #5 by a cycle of ms in cell C by a CSI-RS (e.g., an NZP-CSI-RS) of another cell (cell G), and thus DU 1 transfers an interference report (e.g., slot #5 of a cycle of 20 ms) related thereto, the reference signal allocation control device 100 may extract CSI-RS information of cell G as CSI-RS information of a predetermined cell that matches an interference slot (e.g., slot #5) and an interference cycle (e.g., a cycle of 20 ms) based on the present interference report (e.g., slot #5 by a cycle of 20 ms), and may transfer the same to DU 1.

Accordingly, in case that cell G allocates and uses an NZP-CSI-RS as a CSI-RS, CSI-RS information including an NZP-CSI-RS transmission location of cell G may be transferred/provided as a reply to DU 1 that transfers the inference report associated with its serving cell (cell C).

In this manner, DU 1 may secure CSI-RS information (including an NZP-CSI-RS transmission location) associated with cell G of DU 3 that does not interoperate with DU 1, and, by using the same, may allocate a ZP-CSI-RS for its serving cell, that is, the cell C to the same transmission location (e.g., slot #5 by a cycle of 20 ms) as shown in FIG. 4A in operation S70.

Accordingly, as illustrated in FIG. 4B, cell C of DU 1 may allocate/use, for ZP-CSI-RS transmission, a location of slot #5 by a cycle of 20 ms, that is, a resource location same as that of an NZP-CSI-RS of cell G that is subordinate of DU3 that does not intemperate with DU 1, thereby removing/avoiding interference to transmission data that has occurred in the corresponding location in operation S70.

In the operation method of the reference signal allocation control device according to an embodiment of the disclosure, the reference signal allocation control device 100 may continuously perform the above-described operation S10 and subsequent operations thereto until a CSI-RS allocation control function of the disclosure is turned off (No in operation S80).

Hereinafter, FIG. 6 is a diagram illustrating operation performed in a distributed unit (DU) according to an embodiment of the disclosure. For ease of description, descriptions will be provided with reference to DU 1 as in the above-described embodiments.

According to an embodiment of the disclosure, DU 1 may estimate/identify whether interference to transmission data caused by a CSI-RS is present for each cell (e.g., cell A, B, C) of DU 1 (hereinafter, whether interference to transmission data is present) in operation S41 and S42.

Particularly, according to an embodiment of the disclosure, DU 1 calculates a BLER for each slot by using an HARQ operation for each cell (e.g., cell A, B, C) of DU 1 in operation S41, and based on the BLER calculated for each slot, DU 1 may recognize whether a slot having a BLER greater than a target BLER is present, and may recognize a cycle by which such the interference (the occurrence of a BLER greater than the target BLER) occurs in operation S42.

Describing in detail with reference to FIGS. 3A and 3B, as illustrated in FIG. 3A, it is assumed that another cell (e.g., cell G) that is adjacent to a cell of DU 1, is controlled by another DU (e.g., DU 3), and allocates a CSI-RS (e.g., an NZP-CSI-RS) to a location of slot #5 by a cycle of 20 ms, is present.

In this instance, as illustrated in FIG. 3B, in the cell (e.g., cell C) of DU 1, interference may occur in data that is transmitted in a resource location same as that of the CSI-RS (e.g., an NZP-CSI-RS) of the adjacent other cell (e.g., cell G), that is, the location of slot #5 at a cycle of 20 ms, and DU 1 may recognize that a BLER greater than a target BLER is produced periodically in a location of slot #5 by a cycle of 20 ms in a cell C of DU 1.

In this instance, DU 1 in the disclosure may estimate/identify that transmission data interference is present with respect to a serving cell (e.g., cell C) in which the transmission data interference is identified as occurring in a location of slot #5 by a cycle of 20 ms among its cells (e.g., cell A, B, C), may produce an interference report related thereto, and may transmit the same to the reference signal allocation control device 100 (e.g., RIC 20) in operation 43.

As described above, the interference report transferred to the reference signal allocation control device 100 (e.g., the RIC 20) may be received from a DU (e.g., DU 1) of a cell (e.g., cell C) that is identified as experiencing transmission data interference, and may include an interference slot and an interference cycle (e.g., slot #5 by a cycle of 20 ms) in association with the identified transmission data interference.

Accordingly, in the operation method of a reference signal allocation control device according to an embodiment of the disclosure, the reference signal allocation control device 100 may transfer, to DU 1 of cell C, CSI-RS information of a predetermined cell that is controlled by another DU (e.g., DU 2, 3, . . . ) instead of DU1, and that matches an interference slot (e.g., slot #5) and an interference cycle (e.g., a cycle of 20 ms) based on the present interference report (e.g., slot #5 by a cycle of 20 ms) from among the CSI-RS information of each cell (e.g., cell A, B, C, H, I, . . . ) managed in advance for each DU (e.g., DU 1, 2, 3, . . . ) via operation S60 with reference to FIG. 5.

Accordingly, in case that cell G allocates and uses an NZP-CSI-RS as a CSI-RS, CSI-RS information including an NZP-CSI-RS transmission location of cell G may be transferred/provided as a reply to DU 1 that transfers an inference report associated with its serving cell (cell C).

In this manner, according to an embodiment of the disclosure, DU 1 may secure, via transferring/provision as a reply, CSI-RS information (including an NZP-CSI-RS transmission location) associated with cell G of DU 3 that does not interoperate with DU 1, and, based thereon, may allocate a ZP-CSI-RS for its serving cell, that is, the cell C to the same transmission location (e.g., slot #5 by a cycle of 20 ms) in operation S44.

According to an embodiment of the disclosure, DU 1 may identify whether transferred information indicating cancellation of use of the CSI-RS information that is used for ZP-CSI-RS allocation is updated in operation S45.

For example, in the operation method of the reference signal allocation control device according to an embodiment of the disclosure, the reference signal allocation control device 100 may transfer/update information indicating cancellation of use of CSI-RS information of cell G of which deletion is identified to DU 1 that uses, for ZP-CSI-RS allocation, CSI-RS information of cell G of which deletion is identified, via operation S30 with reference to FIG. 5.

In this manner, DU 1 in the disclosure may identify the existence of CSI-RS information update (Yes in operation S45) and may cancel the use of CSI-RS information of cell G, and thus DU 1 may cancel ZP-CSI-RS allocation that is allocated in advance to its serving cell, that is cell C, by using CSI-RS information (including an NZP-CSI-RS transmission location) of cell G, and may utilize corresponding resource for data transmission in operation S46, and thus unnecessary ZP-CSI-RS allocation may be reduced.

According to an embodiment of the disclosure, DU 1 may continuously perform the above-described operation S41 and subsequent operations thereto, until a control function of the reference signal control device 100 is turned off (No in operation S47).

As described above, according to the disclosure, by implementing a detailed technique in a DU and a higher layer of the DU, even though cells do not interoperate with the same DU, the cells may recognize a CSI-RS transmission location in each cell in real time and may use the same for ZP-CSI-RS allocation.

Therefore, according to an embodiment of the disclosure, in consideration of a radio environment that dynamically varies, there may be provided an effect that minimizes a decrease in resources usable for data transmission due to overuse of ZP-CSI-RS allocation, and that also minimizes interference between a CSI-RS and a PDSCH. Accordingly, the performance of transmission may be improved.

The operation method of the reference signal allocation control device according to an embodiment of the disclosure, that is, dynamic CSI-RS allocation technique may be implemented in the form of a program command executable by various computer devices, and may be recorded in a computer-readable medium. The computer-readable medium may include a program command, a data file, a data structure, and the like independently or in combination. The program command recorded in the medium may be designed or configured especially for the disclosure or may be publicly known to those skilled in the computer software field and may be allowed to be used. Examples of a computer-readable recording medium may include magnetic media such as a hard-disk, a floppy disk, and a magnetic tape, optical media such as a CD-ROM, a DVD, and the like, magneto-optical media such as a floptical disk, and a hardware device specially configured to store and perform program commands such as ROM, RAM, flash memory, and the like. In addition, the program commands may include, for example, high class language codes, which can be executed in a computer by using an interpreter and the like, as well as machine codes made by a compiler. The above-mentioned hardware device may be configured to operate as one or more software modules in order to perform operations in the disclosure, and vice versa.

Although the disclosure has been described in detail with reference to various embodiments, the disclosure is not limited to the above-described embodiments, and the technical idea of the disclosure may have the scope within which those skilled in the art field of the disclosure are capable of making various modifications or corrections without departing from the subject matter of the disclosure claimed in the following claims.

What is claimed is:

1. A reference signal allocation control device comprising:
an interference report receiver configured to receive an interference report associated with interference to a cell by another cell that does not interoperate with a distributed unit (DU) of the cell; and
a controller configured to transfer reference signal information related to the interference report to the DU of the cell so that the DU allocates a reference signal for avoiding interference to the cell based on the transferred information.

2. The reference signal allocation control device of claim 1, further comprising:
an information management unit configured to periodically collect, from a plurality of DUs, reference signal information of each cell that includes a reference signal transmission location of cell controlled by each of the plurality of DUs,
wherein the controller transfers, to the DU of the cell, reference signal information of a specific cell specified by the interference report among the reference signal information of each cell collected for each of the plurality of DUs.

3. The reference signal allocation control device of claim 2, wherein, when a deleted cell is identified based on information collection by the information management unit, the controller transmits information indicating cancellation of use of reference signal information of the deleted cell to a DU that uses the reference signal information of the deleted cell for allocating an interference avoidance reference signal.

4. A distributed unit (DU) comprising:
an information securing unit configured to secure CSI-RS information associated with a cell of another DU that causes interference to a cell of the DU due to a CSI-RS; and
an allocator configured to allocate a reference signal for avoiding interference to the cell of the DU based on the secured information.

5. The DU of claim 4, wherein the information securing unit secures the CSI-RS information associated with the cell of the another DU by transferring an interference report associated with the cell of the DU to a higher layer of the DU and receiving a response.

6. The DU of claim 5, wherein the interference report comprises an interference slot and an interference cycle based on a result obtained by identifying whether transmission data interference occurs for each cell controlled by the DU.

7. A radio unit (RU) interoperating with a distributed unit (DU), the RU comprising a reference signal transmitter configured to transmit an interference avoidance reference signal in a resource location in which a CSI-RS of another cell that does not interoperate with the DU is transmitted, so that interference between transmission data and the CSI-RS of the another cell in the resource location is avoided.

8. The RU of claim 7, wherein, when the another cell is deleted, the reference signal transmitter cancels transmission of the interference avoidance reference signal in the resource location so that the resource location is used for data transmission.

9. The RU of claim 7, wherein the interference avoidance reference signal is a zero power-channel state information-reference signal (ZP-CSI-RS).

10. An operation method of a reference signal allocation control device, the operation method comprising:
receiving an interference report associated with interference to a cell by another cell that does not intemperate with a distributed unit (DU) of the cell; and
transferring reference signal information related to the interference report to the DU of the cell so that the DU allocates a reference signal for avoiding interference to the cell based on the transferral information.

11. The operation method of claim 10, further comprising:
periodically collecting, from a plurality of DUs, reference signal information of each cell that includes a reference signal transmission location of cell controlled by each DU of the plurality of DUs,
wherein the transferring comprises transferring reference signal information of a specific cell specified by the interference report to the DU of the cell among the reference signal information of each cell collected for each of the plurality of DUs.

12. The operation method of claim 11, further comprising:
transferring, when a deleted cell is identified based on information collection, information indicating cancellation of use of reference signal information of the deleted cell to a DU that uses the reference signal information of the deleted cell for allocating an interference avoidance reference signal.
